(19) United States
(12) Patent Application Publication
(10) Pub. No.: US 2011/0258337 A1
(43) Pub. Date: Oct. 20, 2011

(54) METHOD AND SYSTEM FOR ENABLING ZERO-COPY TRANSMISSION OF STREAMING MEDIA DATA

(75) Inventors: Weiqiang Wang, Guangdong (CN); Hongjun Zhu, Guangdong (CN); Jian Cheng, Guangdong (CN)

(73) Assignee: ZTE CORPORATION, Shenzhen City, Guangdong (CN)

(21) Appl. No.: 13/057,625

(22) PCT Filed: Jul. 30, 2009
(86) PCT No.: PCT/CN2009/000852

§ 371 Date: Apr. 20, 2011

(30) Foreign Application Priority Data
Aug. 4, 2008 (CN) 200810142292.7
Dec. 26, 2008 (CN) 200810241596.9

(51) Int. Cl. G06F 15/16

(52) U.S. Cl. 709/231

(57) ABSTRACT

A method and system for implementing zero copy transmission of streaming media data are disclosed in the present invention, and the method and system are based on Linux network protocol stack. The method comprises: when a streaming media server receives a data request from a user equipment, it performs a system call of data transmission, reading the streaming media data out from the disk space and writing it into a user data buffer; packaging the streaming media data stored in the user data buffer as real-time transmission protocol packets which are transmitted applying streaming media packets whose head and load are separated. The method and system of the present invention sufficiently use the DMA function and SG (Scatter/Gather) function of a network card to implement zero-copy transmission of the streaming media data.

### TECHNICAL FIELD

The present invention relates to a method and system for network communication in the field of computer applications, and more especially, to a method and system for enabling zero copy transmission of streaming media data based on the linux network protocol stack.

### BACKGROUND OF THE RELATED ART

In the prior art, massive streaming media data should be transported from the disk to the network in the streaming media server applications based on the Linux operating system. When the streaming media data is being transported from the disk to the network, it needs to be transported for several times in different system spaces.

The transport process mainly comprises the following three parts: (1) read the streaming media data out the disk space and write it into the user data buffer; (2) package the streaming media data stored in the user data buffer into RTP (Real-time Transport Protocol) packets and store them in the user transmission buffer; (3) send the RTP packets stored in the user transmission buffer out with the UDP (User Datagram Protocol) network socket.

In the Linux operating system, the user process can read disk data through direct I/O interface system call, and the system call directly writes the disk data into the user buffer via the DMA (Direct Memory Access) mechanism; with the UDP network socket related system call interface, the RTP packets can be sent out, and the system call copies the RTP packets from the user space to the kernel space and correspondingly encapsulates the packets, and then maps the packets to the transmission buffer of the network card via the DMA mechanism, and finally the network card sends the RTP packets out.

In the method of the prior art, the user process can read streaming data out from disk with zero copy, however, the data copy is required when the streaming media data is packaged into RTP packets, moreover, the data should be copied from the user space to the kernel space when the RTP packets are sent.

Moreover, every time the user process sends a packet, it needs to use the system call for one time, and in each time, the system call should switch from the user state to the kernel state, and after the system call returns, it switches back from the kernel state to the user state. In the condition that the streaming media server is heavily loaded, massive data copying and context switching would be triggered, which extremely consumes system CPU resource and decreases the system processing ability.

It can be seen that the overhead in the streaming media packet transmission is mainly generated in data organization, data copy and data transmission at different levels such as the user process, operating system, and network card driving. How to effectively reduce the number of data copies and system calls, reduce the CPU usage, increase the system processing ability is very important to improve the performance of the streaming media server.

Therefore, the prior art should be improved and developed.

### Content of the Invention

The purpose of the present invention is to provide a method and system for implementing zero copy transmission of streaming media data, and the method and system are based on the Linux network protocol stack, and in the condition that the original network protocol stack of the Linux system is not affected, the method and system reduce the CPU usage due to the data copy and system call as much as possible, thus improve the system processing ability.

In order to achieve the above-mentioned purpose, the technical scheme of the present invention comprises:

A method for implementing the zero copy transmission of streaming media data, and the method is based on the Linux network protocol stack, wherein, the method comprises the following steps of:

A. when a streaming media server receives a data request from a user equipment, it performing a system call of transmission data and reading the streaming media data from the disk space and writes it into the user data buffer;

B. packaging the streaming media data stored in the user data buffer into the real-time transport protocol packets; transmitting these real-time transport protocol data packages in the form of streaming media packets whose head and load are separated.

Furthermore, in the method, the step B also comprises:

B1. allocating a kernel buffer structure in the kernel space for each to-be-transmitted real-time transport protocol packet, and the structure comprises two parts: one part is the temporarily allocated kernel buffer including the head of the real-time transport protocol packet; the other part is the temporarily mapped user buffer including the load of the real-time transport protocol packet;

B2. using the scatter/gather function and the direct memory access function of the network card, mapping the two part buffers of the kernel buffer structure to the transmission buffer of the network card, and calling the transmission function of the network card driver module to implement zero copy transmission of the streaming media data.

Furthermore, in the method, when the streaming media service is required to process requests from a plurality of users, it needs to send one streaming media packet to each user with one system call.

Furthermore, in the method, the network protocol stack provides the following socket programming interfaces: “socket” which is used to create the socket, “close” which is used to close the socket, “sendmsg” which is used to implement the zero copy transmission of the streaming media data.

A system for implementing zero copy transmission of streaming media data comprises the streaming media server, and the streaming media server is configured to implement the zero copy transmission of the streaming media data based on the Linux network protocol stack. Wherein, the streaming media server configures a kernel space between the hardware device and the user process, and configures a network protocol stack above the network card driver program in the kernel space; the kernel space allocates for real-time transport protocol packets formed by packaging the to-be-transmitted streaming media data the following buffers:
a temporarily allocated kernel buffer to include the head of the real-time transport protocol packets, and
a temporarily mapped user buffer to include the load of the real-time transport protocol packets;

The network protocol stack provides socket programming interfaces for the user process, and the socket programming interfaces comprise: “socket” used to create the socket, “close” used to close the socket, and “sendmsg” used to implement the zero copy transmission of the streaming media data; the network protocol stack is used to send the real-time transport protocol packets in the form of streaming media packets whose head and load are separated.

Furthermore, in the system, the streaming media server applies the batch transmission technology to send a plurality of packets in one system call of “sendmsg”.

Compared with the network protocol stack in the Linux kernel in the prior art, the method and system for implementing the zero copy transmission of the streaming media data provided in the present invention implement the zero copy transmission of the streaming media data by sufficiently using the DMA and SG (Scatter/Gather) functions of the network card and implement the transmission of the streaming media packets whose head and load are separated, thus reduce one data copy operation in the process of RTP packaging the streaming media data.

### BRIEF DESCRIPTION OF DRAWINGS

FIG. 1 illustrates the process of using the network protocol stack realized in the present invention to perform zero copy transmission of the streaming media data;

FIG. 2 illustrates the structure of the system in accordance with the present invention.

### PREFERRED EMBODIMENTS OF THE PRESENT INVENTION

In the following, the preferred embodiments of the present invention will be described in further detail with reference to the accompanying figures.

In the method for realizing zero copy transmission of the streaming media data based on the Linux network protocol stack in accordance with the present invention, the original Linux network protocol stack which is realized with the kernel module mechanism will be used, loading and unloading of the kernel module will not affect the original network protocol stack of the Linux kernel. The system for realizing zero copy transmission of the streaming media data in the present invention comprises a streaming media server, as shown in FIG. 2, the streaming media server is configured with a network card for communicating with the user equipment. Said network card supports the DMA and SG (Scatter/Gather) functions.

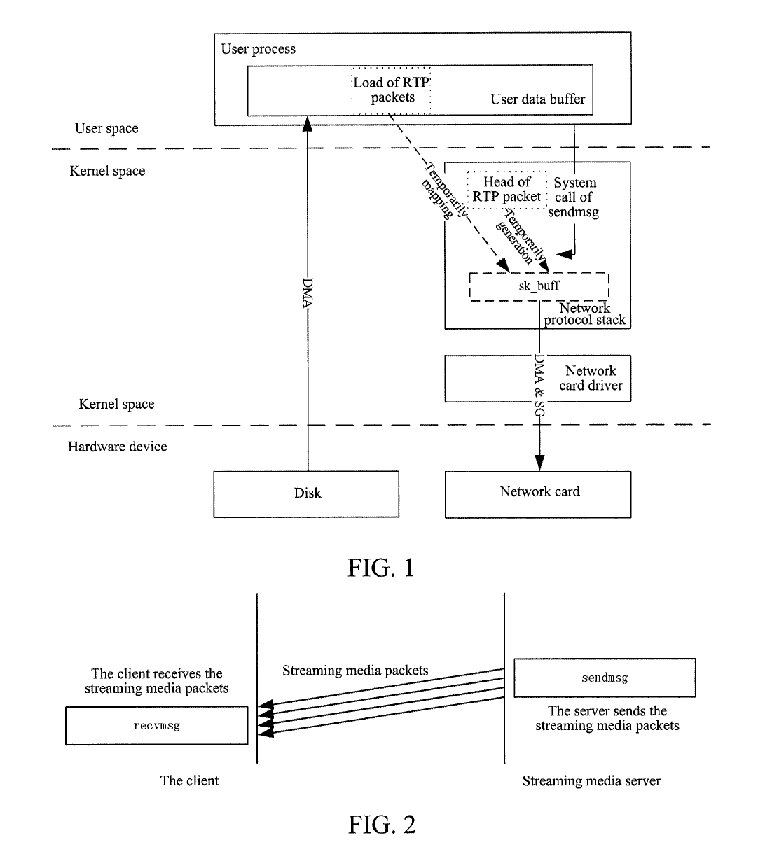

In said method and system of the present invention, the hardware devices of said streaming media server comprise a network card and a disk, as shown in FIG. 1, Linux kernel space is located between the hardware device and user process, the network protocol stack is configured above the network card driver program in the kernel space, and said network protocol stack provides a socket programming interfaces to the user process, and said socket programming interfaces mainly comprise system calls such as “socket”, “close” and “sendmsg”, wherein, “socket” is used to create the socket, “close” is used to close the socket and “sendmsg” is used to realize zero copy transmission of the streaming media data.

The hardware environment of the method and system in accordance with the present invention requires that the network card has the DMA and SG functions, and the software environment is the Linux kernel having proper network functions. In order to realize the function of zero copy transmission of the streaming media data, the method and system of the present invention create the DATALINK network protocol stack based on the socket type of AF_DATALINK on the basis of the original Linux kernel. The protocol stack provides the user process the AF_DATALINK types of socket programming interfaces including the system calls such as “socket”, “close” and “sendmsg”. Wherein, the system call of “socket” is used to create the socket, the system call of “close” is used to close the socket, and the system call of “sendmsg” is used to send the streaming media data in the form of RTP packet encapsulation with zero copy.

The conventional standard semantic of “sendmsg” in the prior art cannot be able to realize the function of the present invention, thus “sendmsg” should be redefined. In the following, the “sendmsg” in the method and system of the present invention is defined and explained:

ssize_t sendmsg(int socket, const struct msghdr *msg, int flags);

Function:

zero copy transmission of the streaming media data is realized with socket.

Input and output parameters:

socket, a socket of AF_DATALINK created using the system call of “socket”;

msg→msg_name: temporarily unused.

msg→msg_namelen: temporarily unused.

msg→msg_iov: an input parameter, the pointer pointing to the array of struct iovec. Each struct iovec comprises the buffer address and length of the to-be-transmitted data.

msg→msg_iovlen: an input parameter to store the length of the array of struct iovec to which msg_iov points.

msg→msg_control: an input-output parameter to store the control information including the IP address, UDP port and RTP load type of each streaming media packet during the input; and to return the index and error code of the packets incorrectly transmitted.

msg→msg_controllen: an input parameter used to store the total length of the msg_control message.

msg→msg_flags: temporarily unused.

flags: temporarily unused.

Returned value:

If the packets are not transmitted successfully, return −1 and set the error code errno.

If some or all packets are transmitted successfully, return the number of the successfully transmitted packets, the index of the packets which are not transmitted successfully and the corresponding error code via the output parameter.

The information of which the RTP packets consist is stored in the parameter of msg, and msg_iov stores the load information of the to-be-transmitted RTP packets comprising the address and length information of the user data buffer as load of RTP packets; msg_control stores the head information of the to-be-transmitted RTP packets comprising the IP address, port number, RTP load type used for generating the head of RTP packets.

As shown in FIG. 1, the method of the present invention allocates the kernel buffer structure sk_buffer for each to-be-transmitted RTP packet in the kernel space during the system call of “sendmsg”, and the data of this structure consists of two parts: one part is the temporarily allocated kernel buffer including the head of the streaming media RTP packet which is generated according to the head information included in msg_control; the other part is the temporarily mapped user buffer including the load of the RTP packet which is obtained according to the load information included in msg_iov. With the SG and DMA functions of the network card, these two buffers are mapped to the transmission buffer of the network card, and the transmission function of the network card driving module is called to complete the zero copy transmission of the streaming media data. The above-mentioned mapping process is known in the prior art and will not be described here.

When the streaming media server in the method and system of the present invention processes a single user request, the zero copy transmission of the streaming media data could be realized with socket of AF_DATALINK and one system call of “sendmsg”.

When the streaming media server needs to process a plurality of user requests, besides of using the zero copy transmission of streaming media data similar to the case of the single user request, the system performance can be further optimized by reducing the number of system calls: this mainly owes to meaning redefinition for the parameter msg used for the system call of “sendmsg”, its member msg→msg_iov points to a batch of packet buffers, and the member msg→iovlen denotes the number of the packet buffers. One system call could send a batch of streaming media packets, and in practical applications, one streaming media packet is sent to each user in one “sendmsg” to reduce the number of the system calls of “sendmsg”, thus to optimize the system performance.

The method and system of the present invention sufficiently use the DMA and SG functions of the network card to realize zero copy transmission of the streaming media data. Compared with the conventional network protocol stack of the Linux kernel, the method and system of the present invention use the SG function of the network card to realize the transmission of the streaming media packets whose head and load are separated, thus reduce one data copy needed in the process of RTP packaging the streaming media data.

Meanwhile, with the DMA function of the network card, the network card driver module directly uses the user buffer to transmit the packets, thus reduce one data copy operation needed in the process of copying the streaming media data from user space to kernel space.

The method and system of the present invention apply the batch sending technology to realize the function of sending a batch of packets with one system call, thus avoid the case that one system call is needed to send a packet, reduce the overhead of system calls when sending a plurality of users the streaming media data. The implementation of said batch sending technology is known by those skilled in the field and will not be described here.

It should be noted that the above-mentioned network protocol stack is realized with software, and the implementation of system calls is known in that of existing software, whose specific procedure is familiar to those skilled in the art and not discussed in detail here.

Meanwhile, it should be noted that, the preferred embodiments of the present invention are described in detail, however, they should not be considered as limit of the protection scope of the present invention and the protection scope of the present invention is defined by the claims.

### INDUSTRIAL APPLICABILITY

The method and system of the present invention fully use the DMA and SG functions of the network card to realize the zero copy transmission of the streaming media data. Compared with the conventional network protocol stack of the Linux kernel, the method and system of the present invention use the SG function of the network card to realize the transmission of the streaming media packets whose head and load are separated, thus reduce one data copy operation needed during the process of RTP packaging the streaming media data.

What we claim is:

1. A method for implementing zero copy transmission of streaming media data, the implementation of the method being based on a Linux network protocol stack, and the method comprising the following steps of:
A. when a streaming media server receives a data request from a user equipment, the streaming media server performing a system call of transmission data, reading the streaming media data from a disk space and writing the streaming media data into a user data buffer;
B. packaging the streaming media data stored in the user data buffer into real-time transport protocol packets; transmitting the real-time transport protocol data packages in a form of streaming media packets whose head and load are separated.

2. A method of claim 1, wherein, said step B further comprises:
B1. allocating a kernel buffer structure in a kernel space for each to-be-transmitted real-time transport protocol packet, and the kernel buffer structure comprising:
a temporarily allocated kernel buffer including a head of said to-be-transmitted real-time transport protocol packet; and
a temporarily mapped user buffer including load of said to-be-transmitted real-time transport protocol packet;
B2. using a scatter/gather function and a direct memory access function of a network card, mapping the temporarily allocated kernel buffer and temporarily mapped user buffer of said kernel buffer structure to a transmission buffer of the network card, and calling a transmission function of a network card driver module to complete zero copy transmission of the streaming media data.

3. A method of claim 2, wherein, when the streaming media service is required to process requests from a plurality of users, the streaming media service transmitting one streaming media packet to each user sending the request with one system call.

4. A method of claim 3, wherein, said network protocol stack provides the following socket programming interfaces:
“socket” which is used to create a socket, “close” which is used to close a socket, “sendmsg” which is used to implement the zero copy transmission of the streaming media data.

5. A system for implementing zero copy transmission of streaming media data, said system comprising a streaming media server, and said streaming media server being configured to implement zero copy transmission of streaming media data based on a Linux network protocol stack, wherein
said streaming media server configures a kernel space between a hardware device thereof and a user process, and configures the network protocol stack above a network card driver program in the kernel space;
said kernel space allocates for real-time transport protocol packets formed by packaging to-be-transmitted streaming media data the following buffers:
a temporarily allocated kernel buffer to include a head of said real-time transport protocol packets, and
a temporarily mapped user buffer to include load of said real-time transport protocol packets;
said network protocol stacks provides socket programming interfaces for the user process, and said socket programming interfaces comprise: “socket” used to create a socket, “close” used to close a socket, and “sendmsg” used to implement zero copy transmission of streaming media data; said network protocol stacks is used to transmit the real-time transport protocol packets in a form of streaming media packets whose head and load are separated.

6. A system of claim 5, wherein, said streaming media server applies batch transmission technology to send a plurality of packets in one system call of “sendmsg”.
